(19) United States
(12) Patent Application Publication
(10) Pub. No.: US 2018/0243699 A1
(43) Pub. Date: Aug. 30, 2018

(54) PVDF DIFFUSION MEMBRANE FOR GAS AND LIQUID TRANSFER

(71) Applicant: 3M INNOVATIVE PROPERTIES COMPANY, St.Paul, MN (US)

(72) Inventors: Amitava Sengupta, North Carolina, NC (US); Chad E. Schuchmann, Charlotte, NC (US); Gareth P. Taylor, Indian Trail, NC (US)

(21) Appl. No.: 15/754,315

(22) PCT Filed: Aug. 24, 2016
(86) PCT No.: PCT/US2016/048333

§ 371 Date: Feb. 22, 2018

Related U.S. Application Data
(60) Provisional application No. 62/209,524, filed on Aug. 25, 2015.

(51) Int. Cl. B01D 69/08; B01D 71/34; B01D 53/22; B01D 69/02; B01D 19/00

(52) U.S. Cl. CPC B01D 69/081; B01D 71/34; B01D 2325/38; B01D 69/02; B01D 19/0031; B01D 53/228

(57) ABSTRACT

In accordance with at least selected embodiments, there are provided a diffusion membrane, a contactor, and/or a method for the removal and/or addition of a gas or a liquid to a second fluid, and the membrane may be a polyvinylidene fluoride (PVDF) hollow fiber membrane, where the diffusion occurs across the membrane.

### FIELD OF THE INVENTION

The instant invention is directed to a novel or improved membrane, diffusion membrane, a gas-liquid or liquid-liquid contactor, and/or a method for the removal and/or addition of a species from one phase to another immiscible phase.

### BACKGROUND OF THE INVENTION

Contactors are used to remove and/or add a gas or a liquid to another immiscible fluid (a gas or a liquid). Such contactors operate on the principle of diffusion (driving force is the concentration gradient), and not on the principle of filtration (exclusion of material by a filter). In a contactor, the diffusion occurs across a diffusion membrane. Whereas in a filter, filtration occurs through a filter. The diffusion membrane and the filter are different. For example, one difference may be in the pore size, the pore size of the filter is normally much greater than the pore size of the diffusion membrane.

The diffusion membranes in commercially available gas-liquid or liquid-liquid contactors are typically microporous hollow fiber membranes. These membranes are made of polypropylene (PP), polyethylene (PE), or polymethylpentene (PMP). Such Liqui-Cel® contactors are commercially available from Membrana-Charlotte of Charlotte, N.C. These are excellent contactors, but in some environments, they may have limitations. Those limitations may include: high oxidation rates when exposed to oxidizing environments (e.g., ozone, peroxide, UV radiation, chlorine, oxygen, air—particularly at elevated operating temperatures); and/or chemical incompatibility (i.e., the membranes swell in the presence of some organic solvents may cause dimensional change, loss of functionality, and/or loss of physical integrity).

Polyvinylidene fluoride (PVDF) hollow fiber membranes are used as filtration membranes, but have not been used as diffusion membranes. The typical PVDF hollow fiber filtration membranes may not be suited for use as diffusion membranes.

Accordingly, there is a need for new diffusion membranes and contactors made from those membranes.

### SUMMARY OF THE INVENTION

In accordance with at least selected embodiments, the present invention may address the above needs and/or provide a diffusion membrane, a contactor, and a method for the removal and/or addition of a gas or a liquid to another immiscible fluid, a polyvinylidene fluoride (PVDF) hollow fiber membrane, where diffusion occurs across the membrane, and/or the like. The diffusion membrane may be hydrophobic in nature. The diffusion membrane may have one of more of the following properties: an internal diameter (ID) of the hollow fiber is in the range of 100-300 microns, an external diameter (OD) of the hollow fiber is in the range of 200-600 microns, a wall thickness of the hollow fiber is in a range of 25-150 microns, a porosity of the hollow fiber is in a range of 20-85%, an average pore size of the hollow fiber is in a range of 0.01-0.5 microns, a bubble point (based on methanol) of the hollow fiber is in a range of 25-250 psi, an implosion pressure of the hollow fiber is in a range of 25-250 psi, a burst pressure of the hollow fiber is in a range of 25-250 psi, an air permeance of the hollow fiber is in a range of 5-50 ml/min-bar-cm², or an operating temperature of the hollow fiber is in a range of 1-99° C.

### DRAWINGS

FIGS. 1a and 1b are schematic cross-section representations of exemplary contactors.

### DESCRIPTION OF THE INVENTION

A diffusion membrane, as used herein, is a hollow fiber or capillary, or flat sheet, film, or foil and may be microporous and hydrophobic. The diffusion membrane of the instant invention may be made by any membrane formation process, for example, the Celgard (or dry-stretch or dry) process or the wet (or thermal inversion or solvent inversion) process. The diffusion membrane is preferably not a nonwoven made by any process, for example wet-laid, air-laid, needle punched, spunlaced, melt-spun, and/or melt-blown processes.

The diffusion membrane, in the instant invention acts a barrier across which diffusion occurs. For example, if a gas is removed from a fluid (liquid or gas), the gas entrained fluid is on one side of the membrane and the gas is diffused across the membrane from the fluid (sometimes a sweep gas may be on the other side of the membrane to facilitate removal of the gas from the fluid). If gas is being added to the fluid, the fluid is on one side of the membrane and the gas is on the other side and the gas is diffused across the membrane into the fluid.

The diffusion membrane is preferably made of polyvinylidene fluoride (PVDF). The PVDF diffusion membrane may be microporous and/or hydrophobic. In one embodiment, the PVDF membrane may have: a high degree of hydrophobicity; small enough pores diameters to prevent aqueous liquid intrusion into the pores under normal operation pressure ranges; internal fiber diameter (ID), external fiber diameter (OD), and fiber wall thickness suitable to withstand external pressure from collapsing the fiber and/or internal pressure from rupturing the fiber; a suitable porosity and tortuosity to allow gas to diffuse relatively unrestricted across the membrane to facilitate good gas transfer performance; and/or a suitable ID to allow for minimal lumen-side pressure drop (gas or liquid); and/or a small enough OD to maximize the amount of active membrane surface are for a given bundle diameter. The PVDF membrane may be a symmetrical membrane (ie, uniform pores diameter through the thickness of the membrane) or an asymmetrical membrane (eg, the pore diameters are tapered form one side of the membrane to the other). If an asymmetric hollow fiber membrane is used the larger pore diameters may be on either the inside surface of the hollow fiber or the outside surface of the hollow fiber.

In one embodiment, the PVDF membrane may have one or more of the following properties: an internal diameter (ID) of the hollow fiber is in the range of about 100-300 microns, an external diameter (OD) of the hollow fiber is in the range of about 200-600 microns. a wall thickness of the hollow fiber is in a range of about 25-150 microns, a porosity of the hollow fiber is in a range of about 20-85%, an average pore size of the hollow fiber is in a range of about 0.01-0.5 microns, a bubble point (methanol) of the hollow fiber is in a range of about 25-250 psi, an implosion pressure of the hollow fiber is in a range of about 25-250 psi, a burst pressure of the hollow fiber is in a range of about 25-250 psi, an air permeance of the hollow fiber is in a range of about 5-50 ml/min-bar-cm², or an operating temperature of the hollow fiber is in a range of about 1-99° C. All ranges mentioned herein include any sub-range included therein.

In another embodiment, the PVDF membrane may have one or more of the following properties: an internal diameter (ID) of the hollow fiber is in the range of about 200-250 microns, an external diameter (OD) of the hollow fiber is in the range of about 250-500 microns, a wall thickness of the hollow fiber is in a range of about 40-75 microns, a porosity of the hollow fiber is in a range of about 25-75%, an average pore size of the hollow fiber is in a range of about 0.03-0.07 microns, a bubble point (IPA) of the hollow fiber is >about 175 psi, an implosion pressure of the hollow fiber is >about 150 psi, a burst pressure of the hollow fiber is >about 75 psi, an air permeance of the hollow fiber is <about 20 ml/min-bar-cm², or an operating temperature of the hollow fiber is in a range of about 15-85° C. All ranges mentioned herein include any sub-range included therein.

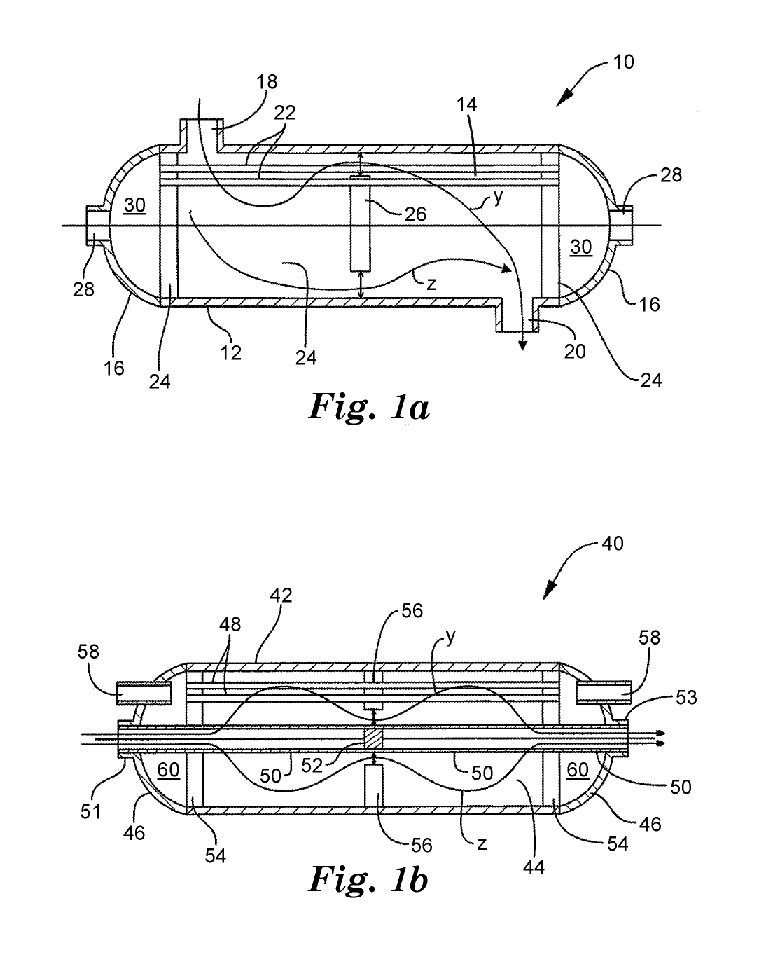

A contactor may be constructed using the PVDF membrane. In one embodiment, a PVDF hollow fiber membrane may be used to construct the contactor. In FIGS. 1a and 1b, there is shown two exemplary and non-limiting embodiments of a contactor. These contactors, along with additional embodiments, are more fully disclosed in U.S. Pat. Nos. 5,264,171 and 5,352,361, which are incorporated herein by reference.

In FIG. 1a, the contactor 10 includes a shell 12, a hollow fiber module 14, and end caps 16. Shell 12 also includes inlet 18 and outlet 20. Module 14 includes a plurality (or bundle) of hollow fiber membranes 22 (only two hollow fiber membranes are shown, but it is understood there are several more filling the shell), tube sheets 24, and a baffle 26 between cap 16 and tube sheet 24. Each end cap 16 includes a port 28 and when the end cap 16 in joined with shell 12, a head space 30 is defined therebetween. The contactor 10 includes a lumen side and a shell side. The lumen side is defined by ports 28, head space 30 and the lumens of the hollow fibers 22. The shell side is defined by inlet 18, a space between inside the shell 12 and between the tube sheets 24 and outside of the hollow fibers 22, and outlet 20. In operation, a vacuum or vacuum/sweep gas may be applied to the lumen side where permeate is removed, and the feed mixture may be introduced into the contactor 10 through the inlet 18 and the retentate is removed at outlet 20. The flow of the feed mixture is indicated by lines z and y.

In FIG. 1b, contactor 40 includes a shell 42, a hollow fiber module 44, and end caps 46. Module 44 includes a plurality (or bundle) of hollow fibers 48 surround (e.g., a fabric of hollow fiber membranes are wound around) a perforated manifold 50 with inlet 51 and outlet 53 and having an internal plug 52, tube sheets 54, and baffle 56. The end caps 46 include ports 58 and when joined with shell 42 define head spaces 60. The contactor 40 includes a lumen side and shell side. The lumen side is defined by ports 58, head space 60 and the lumen side of the hollow fibers 48. The shell side is defined by perforated manifold 50, the space between shell 42, tube sheets 54 and the exterior surfaces of the hollow fibers 48. In operation, a vacuum or vacuum/sweep gas may be applied to the lumen side where permeate is removed, and the feed mixture may be introduced into the contactor 40 through the inlet 51 and the retentate is removed at outlet 53. The flow of the feed mixture is indicated by lines y and z.

A method for removing or adding a gas to a fluid generally includes the steps of: contacting a fluid with one side of the PVDF diffusion membrane, and diffusing a gas across the membrane.

In accordance with at least certain embodiments, aspects, or objects, the instant invention is directed to a novel or improved membrane, diffusion membrane, a gas-liquid or liquid-liquid contactor, and/or a method for the removal and/or addition of a species from one phase to another immiscible phase. In accordance with at least selected embodiments, there are provided a diffusion membrane, a contactor, and/or a method for the removal and/or addition of a gas or a liquid to a second fluid, and the membrane may be a polyvinylidene fluoride (PVDF) hollow fiber membrane, where the diffusion occurs across the membrane. The diffusion membrane may be hydrophobic. The diffusion membrane may have one of more of the following properties: an internal diameter (ID) of the hollow fiber is in the range of 100-300 microns, an external diameter (OD) of the hollow fiber is in the range of 200-600 microns, a wall thickness of the hollow fiber is in a range of 25-150 microns, a porosity of the hollow fiber is in a range of 20-85%, an average pore size of the hollow fiber is in a range of 0.01-0.5 microns, a bubble point (IPA) of the hollow fiber is in a range of 25-250 psi, an implosion pressure of the hollow fiber is in a range of 25-250 psi, a burst pressure of the hollow fiber is in a range of 25-250 psi, an air permeance of the hollow fiber is in a range of 5-50 ml/min-bar-cm², and/or an operating temperature of the hollow fiber is in a range of 1-99° C.

The present invention may be embodied in other forms without departing from the spirit and the essential attributes thereof, and, accordingly, reference should be made to the appended claims, rather than to the foregoing specification, as indicating the scope of the invention.

1. A diffusion membrane for the removal and/or addition of a gas to a fluid comprises:
a polyvinylidene fluoride (PVDF) hollow fiber membrane, and the gas is diffused across the membrane.

2. A diffusion membrane of claim 1 for the removal and/or addition of a dissolved species from one liquid to another immiscible liquid.

3. The diffusion membrane of claim 1 wherein the membrane is hydrophobic.

4. The diffusion membrane of claim 1 further comprising one of more of the following properties:
an internal diameter (ID) of the hollow fiber is in the range of about 100-300 microns,
an external diameter (OD) of the hollow fiber is in the range of about 200-600 microns.
a wall thickness of the hollow fiber is in a range of about 25-150 microns,
a porosity of the hollow fiber is in a range of about 20-85%,
an average pore size of the hollow fiber is in a range of about 0.01-0.5 microns,
a bubble point (methanol) of the hollow fiber is in a range of about 25-250 psi,
an implosion pressure of the hollow fiber is in a range of about 25-250 psi,
a burst pressure of the hollow fiber is in a range of about 25-250 psi,
an air permeance of the hollow fiber is in a range of about 5-50 ml/min-bar-cm², or
an operating temperature of the hollow fiber is in a range of about 1-99° C.

5. The gas diffusion membrane of claim 1 further comprising one of more of the following properties:
an internal diameter (ID) of the hollow fiber is in the range of about 200-250 microns,
an external diameter (OD) of the hollow fiber is in the range of about 250-500 microns.
a wall thickness of the hollow fiber is in a range of about 40-75 microns,
a porosity of the hollow fiber is in a range of about 25-75%,
an average pore size of the hollow fiber is in a range of about 0.03-0.07 microns,
a bubble point (IPA) of the hollow fiber is >about 175 psi,
an implosion pressure of the hollow fiber is >about 150 psi,
a burst pressure of the hollow fiber is >about 75 psi,
an air permeance of the hollow fiber is <about 20 ml/min-bar-cm², or
an operating temperature of the hollow fiber is in a range of about 15-85° C.

6. A contactor for the removal and/or addition of a gas to a fluid comprises:
the diffusion membrane of claim 1.

7. A contactor for the removal and/or addition of a dissolved species from one liquid to another immiscible liquid comprises the diffusion membrane of claim 2.

8. A method for the removal and/or addition of a gas to a fluid comprises the steps of:
contacting a fluid with one side of the diffusion membrane of claim 1, and
diffusing a gas across the membrane.

9. A method for the removal and/or addition of a dissolved species from one liquid to another immiscible liquid:
contacting the first liquid with one side of the diffusion membrane and the second liquid with the other side of the diffusion membrane of claim 2, and
diffusing the dissolved species across the membrane.

10. Novel or improved membranes, diffusion membranes, gas-liquid or liquid-liquid contactors, and/or methods for the removal and/or addition of a species from one phase to another immiscible phase, and/or the like as shown or described herein.
